(19) United States
(12) Patent Application Publication
(10) Pub. No.: US 2019/0135177 A1
(43) Pub. Date: May 9, 2019

(54) METHOD AND SYSTEM FOR AGGREGATION OF BEHAVIOR MODIFICATION RESULTS

(71) Applicant: TRUEMOTION, INC., Boston, MA (US)

(72) Inventors: Kevin Farrell, Windham, NH (US); Brad Cordova, Cambridge, MA (US); Rafi Finegold, Sharon, MA (US); Nick Arcolano, Boston, MA (US)

(73) Assignee: TRUEMOTION, INC., Boston, MA (US)

(21) Appl. No.: 16/124,017

(22) Filed: Sep. 6, 2018

Related U.S. Application Data
(60) Provisional application No. 62/555,429, filed on Sep. 7, 2017.

(51) Int. Cl. B60Q 9/00; G09B 19/00; B60W 40/09

(52) U.S. Cl. CPC B60Q 9/00; B60W 40/09; G09B 19/00

(57) ABSTRACT

Methods and systems include receiving a set of modifiers associated with driving behaviors, generating a subset of the set of modifiers, and transmitting the subset to a mobile device of a driver of a vehicle. The methods and systems include detecting, using the mobile device, a first action of the driver during a drive of the vehicle, pushing one or more modifiers from the subset to the mobile device, and receiving, from the mobile device, a first data corresponding to a first behavior of the driver in response to the pushing of the one or more modifiers. The methods and systems further include detecting changes from the first action to a second action of the driver based on the first data, altering the subset of modifiers to an updated subset of modifiers based on the detecting, and transmitting the updated subset of modifiers to the mobile device of the driver.

### CROSS-REFERENCES TO RELATED APPLICATIONS

This application claims priority to U.S. Provisional Patent Application No. 62/555,429, filed on Sep. 7, 2017, entitled “Method and System for Aggregation of Behavior Modification Results,” the disclosure of which is hereby incorporated by reference in its entirety for all purposes.

### BACKGROUND OF THE INVENTION

Mobile devices, such as smart phones, have been utilized to provide location information to users. Mobile devices can use a number of different techniques to produce location data. One example is the use of Global Positioning System (GPS) chipsets, which are now widely available, to produce location information for a mobile device. Some systems have been developed to track driving behaviors including speed, braking, and turn speed. Such systems include external devices that are physically integrated with vehicles to track driving behavior.

Despite the progress made in relation to collecting data related to drivers and their driving behavior, there is a need in the art for improved systems and methods related to sensor-based detection, alerting and modification of driving behaviors.

### SUMMARY OF THE INVENTION

The present disclosure describes utilizing mobile devices to provide information on a user's behaviors during transportation. Utilizing data obtained using sensors associated with the mobile device, the effectiveness of behavior modifiers can be analyzed and sets of behavior modifiers can be updated based on effectiveness.

Numerous benefits are achieved by way of the present disclosure over conventional techniques. For example, the methods and system described herein provide an initial set of behavior modifiers that can be presented to the driver. The performance of the initial set of modifiers is analyzed, which can be considered as determining the effectiveness of the initial set of modifiers as measured by reduction in a risk profile for the driver. The risk profile includes scores that may be assigned to the driver, but provides broader coverage than a score. As described herein, by determining a driver's risk profile and then measuring changes (e.g., improvement) in the risk profile, it is possible to demonstrate that as the driver's risk profile improves, for example, moving from a higher risk profile to a lower risk profile, the driver is less likely to have an accident.

Feedback on performance and/or effectiveness of the modifiers is used to update the initial set to an updated set that is characterized by an increased effectiveness compared to the initial set. Accordingly, the set of modifiers changes over time by operation of the feedback loop as the set of modifiers that are delivered to the driver are updated to an updated set. Because this updated set is updated based on effectiveness, the effectiveness of the behavior modifiers increases over time, resulting in improved driving behaviors and reduced risk. The methods and systems disclosure herein enable quantification of risk based on actual driver behavior and modifications to this behavior as a function of time as a result of the use of effective behavior modifiers.

The methods and systems disclosure herein can fuse driving behaviors from a plurality of drivers, each of the drivers potentially having different driving skill, different experiences interacting with technology, different vehicle characteristics, and the like. Thus, each driver can be characterized by a set of driver attributes that can be used during the analysis of the effectiveness of the behavior modifiers. Given an implementation in which different drivers are given different behavior modifiers, aggregation of the multiple drivers enables correlation of effectiveness that can be individualized or applicable across a cohort. As described more fully herein, a cohort can be an actual grouping of drivers (e.g., one or more drivers) to which modifiers are applied and analyzed to determine or otherwise measure the effectiveness of the various modifiers. Cohorts, in contrast with a time series approach, provide a set of drivers to which a predetermined set of modifiers are applied and effectiveness is measured. Different cohorts can be compared to each other, for example, with overlapping modifiers included in the predetermined set of modifiers. Accordingly, by comparing across cohorts, the effectiveness of the various modifiers can be ascertained. Cohorts may be utilized to collect, group, analyze, measure, and visualize the results of the behavior change.

As an example, a particular cohort (i.e., grouping of people) can be populated in many ways—1) total random round robin, 2) % weighting—e.g., we want a cohort with 5%, another with 25%, etc., 3) by demographic characteristic(s), 4) geography, 5) other groupings, 6) any combination of these methods or based on other factors. Given these different and diverse cohorts, the effectiveness of the behavior modifiers can be measured and the cohorts compared against each other. One of ordinary skill in the art would recognize many variations, modifications, and alternatives.

These and other embodiments of the invention along with many of its advantages and features are described in more detail in conjunction with the text below and attached figures.

### BRIEF DESCRIPTION OF THE DRAWINGS

Illustrative embodiments of the present invention are described in detail below with reference to the following drawing figures:

FIG. 1 is a system diagram illustrating a driving behavior detection, alert and modification system according to an embodiment of the present invention.

FIG. 2 is a system diagram illustrating a driving behavior detection, alert and modification system according to an embodiment of the present invention.

FIG. 3 is a simplified flowchart illustrating a method of updating behavior modifiers according to an embodiment of the present invention.

FIG. 4A is a simplified chart illustrating a set of behavior modifiers and their corresponding attributes according to an embodiment of the present invention.

FIG. 4B is a simplified chart illustrating a set of updated behavior modifiers and their corresponding attributes according to an embodiment of the present invention.

FIG. 5 is a simplified flowchart illustrating another method of updating behavior modifiers according to an embodiment of the present invention.

FIG. 6 is a simplified chart illustrating an updated set of behavior modifiers according to an embodiment of the present invention.

FIG. 7 is a simplified plot illustrating reduction in risk as a function of trips according to an embodiment of the present invention.

FIG. 8 depicts a simplified flowchart illustrating another method of aggregating results of behavior modifiers across multiple cohorts according to an embodiment of the present invention.

### DETAILED DESCRIPTION OF SPECIFIC EMBODIMENTS

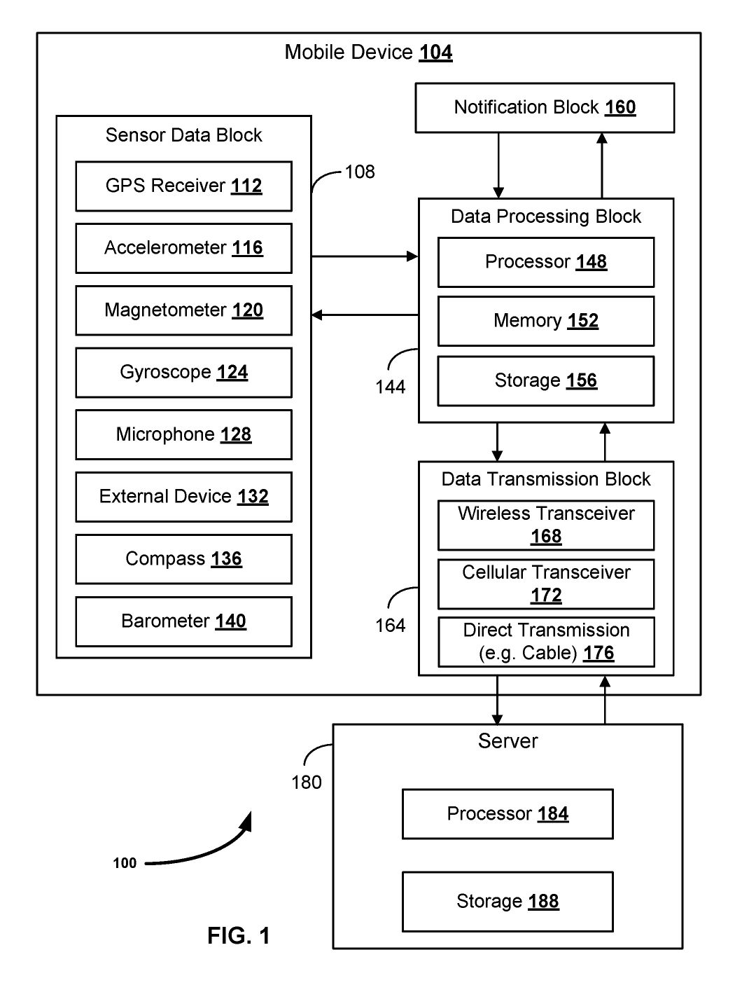

FIG. 1 is a system diagram illustrating a system 100 for collecting driving data according to an embodiment of the present invention. System 100 may include a mobile device 104 having a number of different components. Mobile device 104 may include a sensor data block 108, a data processing block 144, a data transmission block 164, and a notification block 160. The sensor data block 108 may include data collection sensors as well as data collected from these sensors that are available to mobile device 104. This can include external devices connected via Bluetooth, USB cable, etc. The data processing block 144 may include storage 156, and manipulations done to the data obtained from the sensor data block 108 by processor 148. This may include, but is not limited to, analyzing, characterizing, subsampling, filtering, reformatting, etc. Data transmission block 164 may include any transmission of the data off the phone to an external computing device that can also store and manipulate the data obtained from sensor data block 108, such as by using a wireless transceiver 168 a cellular transceiver 172, and/or direct transmission (e.g., through a cable or other wired connection) 176. The external computing device can be, for example, a server 180. Server 180 can comprise its own processor 184 and storage 188. Notification block 160 may report the results of analysis of sensor data performed by the data processing block 144 to a user of the mobile device 104 via a display, a speaker, a haptic alert (e.g., a vibration), etc. (not shown). The terms “notification” and “alert” may be used interchangeably herein. The functions of notification block 160 are described further herein. In some examples, mobile device 104 may further include a scoring block (not shown) to score individual drives or trips, as described further herein.

In some examples, driving data is collected using a mobile device 104. Mobile devices, such as mobile device 104, may include sensors such as, but not limited to: GPS receivers 112, accelerometers 116, magnetometers 120, gyroscopes 124, microphones 128, external devices 132, compasses 136, barometers 140, location determination systems such as global positioning system (GPS) receivers 112, communications capabilities (e.g. radio, Bluetooth, WiFi, cellular networks, etc.), proximity sensors (e.g., radar, lidar, etc.), dot projector, facial recognition (e.g., using one or more cameras), ambient light detectors, infrared detectors, infrared cameras, and the like. Exemplary mobile devices include smart watches, wearable devices, fitness monitors, Bluetooth headsets, tablets, laptop computers, smart phones, music players, movement analysis devices, and other suitable devices. Many variations, modifications, and alternatives may exist without departing from the spirit or the scope of the present disclosure.

To collect data associated with the driving behavior of a driver, one or more sensors on mobile device 104 (e.g., the sensors of sensor data block 108) may be operated close in time to a period when mobile device 104 is with the driver when operating a vehicle—also termed herein “a drive” or “a trip”. With many mobile devices 104, the sensors used to collect data are components of the mobile device 104, and use power resources available to mobile device 104 components, e.g., mobile device battery power and/or a power source external to mobile device 104.

Settings of a mobile device 104 may enable different functions described herein. For example, in Apple iOS, and/or Android OS, having certain settings enabled can enable certain functions. In some instances, having location services enabled allows the collection of location information from the mobile device (e.g., collected by global positioning system (GPS) sensors), and enabling background app refresh allows some aspects of the present disclosure to execute in the background, collecting and analyzing driving data even when the application is not executing. In some implementations, alerts (e.g., audio alerts, haptic alerts, visual alerts, etc.) are provided or surfaced using notification block 160 while the app is running in the background since the trip capture can be performed in the background.

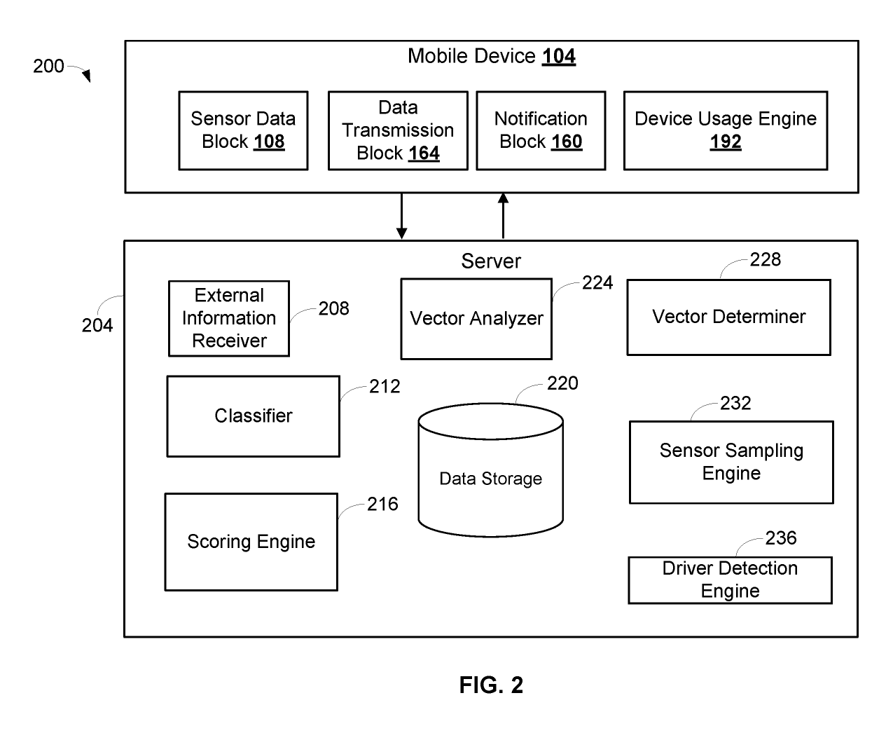

FIG. 2 shows a system 200 for collecting driving data that can include a server 204 that communicates with mobile device 104 according to an embodiment of the present invention. In some instances, server 204 may provide functionality using components including, but not limited to vector analyzer 224, vector determiner 228, external information receiver 208, classifier 212, data collection frequency engine 232, scoring engine 216 and driver detection engine 236. These components are executed by processors (not shown) in conjunction with memory (not shown). Server 204 may also include data storage 256. It is important to note that, while not shown, one or more of the components shown operating within server 204 can operate fully or partially within mobile device 104, and vice versa.

To collect data associated with the driving behavior of a driver, one or more sensors on mobile device 104 (e.g., the sensors of sensor data block 108) may be operated close in time to a period when mobile device 104 is with the driver when operating a vehicle—also termed herein “a drive” or “a trip”. Once the mobile device sensors have collected data (and/or in real time), the data may be analyze to determine acceleration vectors for the vehicle, as well as different features of the drive. Exemplary processes detect and classify driving features using classifier 212, and determine acceleration vectors using vector analyzer 224 and vector determiner 228. In some examples, external data (e.g., environment, GPS, time, road conditions, weather, etc.) can be retrieved and correlated with collected driving data.

The collected sensor data (e.g., driving data collected using sensor data block 108) may be transformed into different results, including, but not limited to, estimates of the occurrence of times where a driver was distracted. Examples of collecting driving data using sensors of a mobile device are described herein. Examples of analyzing collected driving data to detect the occurrence of driving events are also described herein. Although some aspects of the disclosure are discussed in terms of distracted driving and braking events, these aspects are not limited to these particular behaviors and other driving behaviors may be included. Notifications and alerts of driving events may be made via notification block 160 of mobile device 104.

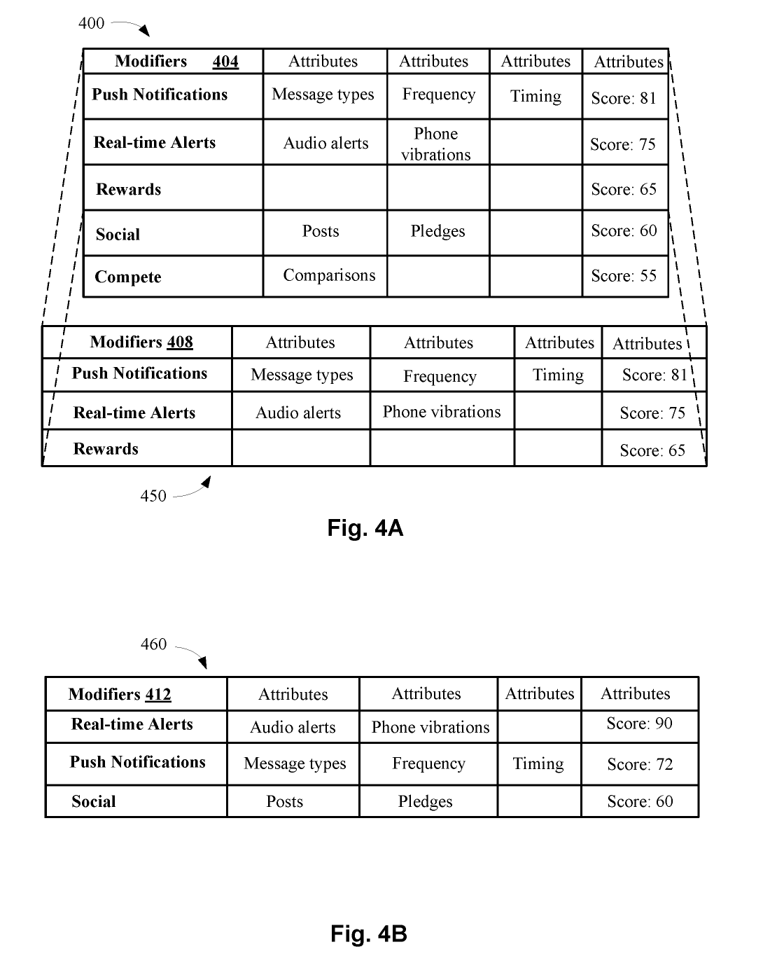

As discussed further below, collected driving data may be analyzed and assign scores based on different criteria. In some examples, scoring engine 216 may analyze relevant data and rules, and generate scores for various examples, modifiers (e.g., see FIG. 4 below), treatments and/or the like.

Notification Block 160 can include received wireless communications from one or more remote devices that may be presented (e.g., displayed via a screen, a vibration, an audible sound, etc.) to a user of the mobile device 104. The communications can include, but are not limited to, push notifications, short messaging service (SMS), email, and alerts as well as other types of “modifiers” (see the description of modifiers below—modifiers, treatments, etc.).

Although shown and described as being contained within server 204, it is contemplated that any or all of the components of server 204 may instead be implemented within mobile device 104, and vice versa. It is further contemplated that any or all of the functionalities described herein may be performed during operation of a vehicle in real time, or after operation of the vehicle has ceased.

A Web Portal (not shown) may also be provided along with mobile device 104 and server 204. The Web Portal may enable access to a database of modifiers along for selection of treatments. The Web Portal may allow drivers, users, and/or companies to review the effectiveness of modifiers, a driving profile of a driver (e.g., including detected actions, available rewards, possible rewards with continued safe driving, etc.), and/or the like. Web Portal, provides administration, visualization and insight into the performance and effectiveness (progress, comparative cohort testing, etc.) of the behavior modification and results

The mobile device associated with the driver may include notifications (e.g., push notifications), alerts as well as a user experience (UX) (e.g., visualizations of driver behavior, rewards, and modifier effectiveness) to help educate and influence the driver. Examples can include how is the driver doing?; how does the driver get better?; rewards; leaderboards; and the like.

A backend processing system may execute data processing, machine learning and data analysis functions.

The methods and systems disclosed herein enable the collection of driver actions and/or behaviors, for example, in response to behavior modifiers pushed to the mobile device associated with the driver, and the use of the collected data in to define behavior modifiers for classes of drivers. In some examples, data related to driver actions for a plurality of drivers can be aggregated and analyzed to leverage the responses from the entire plurality of drivers. Accordingly, the effectiveness of a particular set of behavior modifiers can be measured. In some examples, a set of modifiers can be utilized, as a treatment (e.g., a combination or grouping of modifiers) to address particular driver action types or behavior types. For example, the set of modifiers may be defined to address distracted driving caused by the driver using a mobile device while operating a vehicle. An example of a treatment may 1) a push notification for distraction after the operation of the vehicle has ceased, 2) a vibration of the mobile device if handled by the driver while operating the vehicle, and 3) a weekly summary of your progress. A treatment can be directed at one or more cohorts of drivers. In some examples, a treatment may be evaluated (e.g., scored) along with each individual modifier to determine an effectiveness of each modifier and the treatment. The score(s) may be used to define more effective treatments (e.g., different combinations or groupings of modifiers) or modifiers.

In this disclosure, behavior modifiers can be considered as actions executed by a mobile device and/or methods of engaging with a driver in order to educate or improve the driving behavior of the driver. For example, behavior modifiers can include a variety of actions, messages, or the like that impact the user experience, such as push notifications, SMS messages, enabling/disabling an application feature, enabling/disabling a mobile device feature (e.g., an input interface, a display, vibration capability, a sound (e.g., a beep, an alert, a pre-recorded message, and/or the like), a ringtone or other call or message notification, and/or the like. Push notifications can include messages to the user that include audio, visual (e.g., animation, text, or the like), or a combination thereof. The timing of the push notifications can vary, for example, before the driver operates the vehicle, during operation of the vehicle by the driver, after the driver operates the vehicle, or combinations thereof. The frequency in which modifiers are executed may vary based on one or more factors. For example, modifiers may execute upon each detection of a driver action or execute once per drive.

As described herein, behavior modifiers, in the broad sense of the term, include essentially any method that can be used to influence the behavior of a driver. They can be considered as channels to the customer, for example, a push notification with a particular message at a particular time, the phone vibration/alert, and the like. In addition, behavior modifiers also include other types of “modifiers” that would include social influence (such as a pledge on a social media site or to a family member, that is then monitored and reported on—for example, posted back to the social media site to encourage compliance. Rewards are also included, which include monetary incentives—for example, earning a spin (e.g., in the app) with each hour of consecutive undistracted drive time, where the spin could be a chance to win $100, $1000, an iphone, ipad, etc. Leaderboards and creating competitions are also included—I want to be in the top 10, etc. Also, the category of Comparison—how you compare to others, in the aggregate, how you stack up—for example, you use the phone 25% more than the average user—or, people who use the phone as much as you do are 50% more likely to be in an accident. Combinations of these various modifiers can be combined to produce combined modifiers. One of ordinary skill in the art would recognize many variations, modifications, and alternatives.

In some examples, a modifier may include a reward system in which the driver may be eligible for an award that is reduced upon every detection of an action type within a predetermined time period. For example, a driver may be eligible for a gift card (or monetary award) of a first value every week. Upon detecting an occurrence of a speeding event (or any detectable action), the first value may be reduced to second value which may be further reduced by detecting additional actions. The value may be reduced by different amounts based on the detected action (e.g., more for distracted driving and less for speeding). The value may increase upon extended periods of good driving (absence of detectable actions). In some examples, drivers may compete with other drivers through profiles that display and/or share the actions detected by a mobile device of a driver.

“Modifiers” can include any one or more of Push Notification, Real time Alerts, Rewards, Social Influence, Gamification, Leaderboards, etc. Modifiers can be combined and can be referred to as combined modifiers or “treatments.” Treatments can be directed to one or more cohorts (e.g., groupings of people, random, weighted distribution, demographic, geography, etc.) and those cohorts can then be measured for effectiveness. That effectiveness can then be combined (for example, by pooling the data or crowdsourcing) with the effectiveness of all drivers (across a plurality of insurance companies) to more quickly assess the effectiveness and determine the effectiveness of the treatments, enabling the most effective treatments to rise to the top of the list of potential treatments. Moreover, the whole process is iterative, learning from the feedback, making adjustments, and testing over time.

Different treatments are presented to different cohorts, including a control cohort, which receives no treatment. Different combinations of modifiers are utilized to assemble the various treatments as discussed above. In some examples, cohorts may be selected to receive treatments based on a characteristic of the cohort (e.g., demographic, location, driving record, neighborhood, vehicle type, profession, and/or the like). By measuring the results for each cohort, the effectiveness of the treatments can be determined and treatments can be altered and reapplied to improve the effectiveness of the treatments as a function of time. For example, the effectiveness of treatments and/or individual modifiers may be used enable a selection of one or more modifiers and/treatments to apply to a particular cohort.

For example, for push notifications, the behavior modifier can be characterized by one or more attributes, including the timing of delivery (e.g., immediately after the drive, before the drive, or the like), the frequency, the number delivered, and the like. One or more attributes can be provided that are specific to the different behavior modifiers and enable differentiated messaging with a wide variety, which can then be analyzed to determine the effectiveness of not only the behavior modifiers, but the attributes associated with the behavior modifiers. As described herein, by measuring the differing performance associated with certain behavior modifier/attributes relative to others, both the behavior modifiers and/or the attributes can be adjusted to select the behavior modifier/attributes that result in the greatest improvements in driver behavior. Since different drivers may respond differently to different behavior modifier/attributes, the aggregation of data from many drivers enables analysis that is not possible when only a single driver is considered.

Other exemplary behavior modifiers can include real-time alerts that are delivered to the driver during the drive. These real-time alerts can include audio alerts, including sounds, tones, videos, messages, and the like generated by the mobile device, vibration or other mechanical motion of the mobile device, optical alerts, including flashing lights, display of text or patterns on the screen of the mobile device, or the like.

In addition to behavior modifiers that can be implemented during a drive, other behavior modifiers that are implemented before or after a drive can be utilized, including rewards systems, social media-based systems, or competitions. As an example, using social media, the driver could make pledges that can be tracked and reported on through social media in order to modify the driver's behavior. Competitions in which reductions in the number of distracted behaviors are tracked and posted as an incentive to improve driving behavior can be implemented. As another example, modifiers, such as pre-recorded sound and/or video messages, may be presented to a user. These examples are merely exemplary and are not intended to limit the scope of the present disclosure. Thus, in addition to sound as a type of treatment, embodiments of the present invention can utilize a recording (e.g., sound or video) for playback to the user. During a drive, an audible voice recording (so not to distract the driver) can be utilized. Additionally, video and rich content can be incorporate as components of a treatment that takes place outside of the drive itself, for example, before or after a drive.

In some examples, video messages may provide notify the user of an instance in which the driver was speeding or distracted, provide motivation to operate the vehicle safely, remind the driver of the driver's current driving history over a predetermined period of time, describe the consequences of unsafe operation of the vehicle, and/or the like. For example, the video may motivate/remind the driver that the driver has had three safe trips this week and is eligible for a reward if the driver finishes the week with without a detected unsafe behavior. The video modifier may include pre-recorded of one or more actors, an animated video, an interactive video, a user interface that presents content to the user (e.g., the user's drive stats), and/or the like. Since video is more likely to distract the driver while driving, the video modifier may be presented during times in which the driver is not operating the vehicle (e.g., before or after the drive), while the sound modifier may be presented during the drive as it is less likely to distract the driver.

Compound behavior modifiers (i.e., treatments) are also included within the scope of the present disclosure and can be a collection of two or more behavior modifiers. An example of a compound behavior modifier is phone vibration followed by push notification after the drive with a message related to the level of distraction of the driver during the drive. Compound behavior modifiers are not limited to those associated with a single drive, but can be a collection that are associated with multiple trips or drives, for example, daily behavior modifiers, behavior modifiers extending over several (e.g., after five) trips, weekly behavior modifiers, extended summaries, and the like.

Methods and systems for visualizing and showing the user their progress, for example, on the mobile app or web portal are disclosed. Such visualization can be a modifier as well, since it can be used to influence improvement and provide the user with a reference point for their progress. Thus, visualizations may be provided at both the Mobile/End user level for the driver, as well as for other system users, including at the Insurer level.

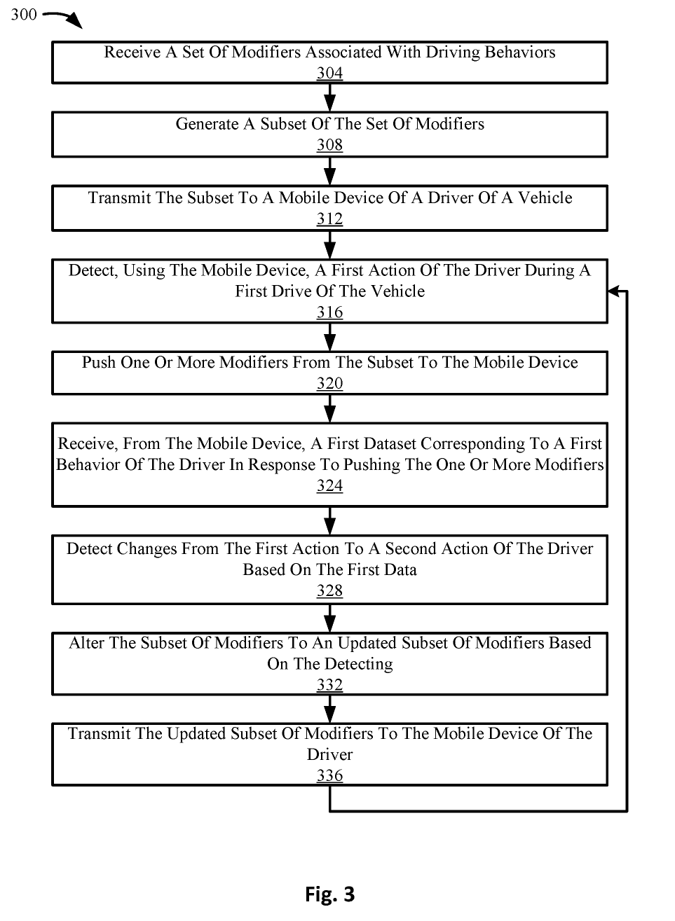

FIG. 3 is a simplified flowchart 300 illustrating a method of updating behavior modifiers according to an embodiment of the present invention. As described herein, methods of providing and aggregating behavior modifiers are included herein. The flow begins at block 304, in which a previously generated set of modifiers (e.g., described more fully in connection to FIG. 4A-4B below) associated with driving behaviors are provided.

Next, in block 308, a subset 450 of the set of modifiers, are generated, such as modifiers 408 shown in FIG. 4A. In some examples, modifier(s) 408 and their attribute(s) are selected from set 400 based on an initial determination, such as based on the Score attribute for each of modifier(s). As shown in FIG. 4A, modifier(s) 404 may include a Score attribute such as 81 for Push Notification, 75 for Real-Time Alerts, and 65 for Rewards, with each score representing a determined effectiveness of their respective modifiers 404 for changing the behavior of a driver. The determination of the effectiveness score for each modifier may be determined: (a) predictively, such as assigned via an algorithm, (b) based on an aggregate results from the behavior of a plurality of drivers cumulated over a time period, or (c) other methods.

Next, in block 312, the subset 450 of modifiers 408 are provided, such as assigned to, the driver of a vehicle and then transmitted to the mobile device 104 associated with the driver. For example, a driver may register a mobile device with a server, such as server 204, to enable monitoring of the driver's behavior. The driver may register the mobile device as part of a rewards system that rewards the driver based on particular behavior and/or responsiveness to the modifiers.

In block 316, using the mobile device 104, a first action of the driver is detected during a first drive of the vehicle. In some examples, the first action(s) may be speeding, sudden braking, placing, receiving, or conducting a call while driving, texting while driving, and/or the like. In some examples, this first action(s) may be used as a “Baseline” performance, which establishes a baseline of a Risk Profile for the driver prior to providing any modifier(s) 408, and from which subsequent changes in the driving actions or behavior of the driver can be measured.

Next, in block 320, one or more modifiers 402 in the provided subset 450 are pushed to the driver via the mobile device 104 based on the detected first action in block 316. For example, in response to detecting a first action of speeding, the one or more modifier may include triggering an audible alert providing a notification to the driver that the driver is speeding. In some examples, the pushed modifier(s) 404, such as Push Notifications, act as interactive tools to engage the driver, and which can vary based a number of factors, for example the timing of their occurrence (e.g., immediately after or before the drive, immediately upon detecting the first action, and frequency of the delivery), as well as in their attributes in different kind of messages, each of which could have a different performance relative to others.

Next, in block 324, data is received from the mobile device 104 based on the provided modifier(s) 402, and corresponding to a first behavior of the driver during the driving of the vehicle in response to the pushing of the one or more modifiers.

In block 328, changes are detected from the first action of the driver to a second action or behavior of the driver in response to pushing the modifier(s) 408. In some examples, data is received from the mobile device 104 that corresponds to the subsequent second driving action of the driver following the pushing of the modifier(s) 404 at block 320. This data is then compared to the driving data received in block 345 to detect any changes in the driver's characteristics from prior to the receipt of the pushed modifier(s) 408 to after the receipt of the pushed modifier(s) 408. This change can then be attributed to the pushed modifier(s) 408, and from which a degree of effectiveness of the pushed modifier(s) 408 on the driving behavior of the driver can also be determined. Based on this determined degree of effectiveness, the Score attribute of modifier(s) 408 can be updated. In some examples, the detection of changes in the driver's behavior can be performed over a predetermined time period, such as hours, days, months, years, or the like.

In some examples, the subsequent behavior of the driver is compared to a predetermined driving behavior, such as a model driving behavior, over a predetermined time period. Then a change, such as a reduction in risk, is determined in the deviation of the subsequent behavior from the predetermined behavior in response to pushing the modifier(s) 408. In some examples, the reductions in risk are measured by decreases in detrimental occurrences, such accident frequency, speeding, decrease in hard braking events, mobile device use while operating a vehicle, or the like. This determined change may then be used for a risk metrics evaluation of the driver, such as a safe driving score, based on which, the driver's insurance rates, premiums, deductibles, etc. may be determined.

Next, in block 332, based on the detected changes in driver behavior, the provided set 450 of modifier(s) 408 may be altered to an updated set 460 of modifiers 412, as shown in FIG. 4B. In some examples, the altering is based on comparing the change detected in block 328 to a predetermined effectiveness threshold for the pushed modifier(s) 408. In some examples, the effectiveness threshold is a reduction in the risk (e.g., via a score). For example, if an audible alert modifier caused a first action of speeding to be eliminated or reduced to a predetermine frequency of occurrence, the audible alert modifier may receive a higher score and be included in the updated set 460. If the audible alert was ineffective in reducing the speeding action, then the audible alert may be removed from the updated set 460 or replaced with another modifier. The updated set 460 may include more, less, or a different collection of modifiers. In some examples, the updated set 460 may include the same modifiers with updated scores (e.g., that may be high, lower, or the same).

In some examples, certain modifier(s) 408 might be determined to be not effective relative to their Score attribute(s) for a driver, which may then result in a lowering of their effectiveness Score(s) for that driver, or overall. In the example shown in FIGS. 4A-4B, Push Notification modifier 408 was originally assigned an effectiveness Score of 81, but following the detecting in block 332 it may be determined as not effective as would be expected given the effectiveness Score, which is then lowered to 72 in the Push Notification modifier 412 in the updated set 460, as shown in FIG. 4B. Likewise, Real-time Alerts modifier 408 having an original score of 75 in set 450 may receive an increased effectiveness Score of 90 as modifier 412 in the updated set 460, and thus ranked relatively higher in the updated set 460 than in set 450.

In addition, certain modifier(s), such as Rewards, might be removed following the detecting and replaced with other modifier(s) from set 400, such as with Social Media. The list of modifier(s) 404 in set 400 may also get altered, or replaced by newly introduced modifiers, some of which may then get assigned to a driver. As a result, the generated set 400, as well as, a set of modifier(s) selected for and assigned to a driver may be updated on an ongoing basis.

Next, in block 336, the updated set 460 of modifier(s) 412 are transmitted to the mobile device 104 for subsequent iterations in blocks 316-336 of FIG. 3.

FIG. 4A is an exemplary chart illustrating a set 400 of exemplary behavior modifiers and their corresponding attributes according to an embodiment of the present invention. In some examples, the modifier(s) 404, such as Push Notification, Real-Time Alerts and Rewards, may each be characterized by one or more attributes. For example, a Push Notification modifier may be characterized by attributes such as Message type (e.g., text of the message), frequency of the messages (e.g., one message every minute), and timing of the messages (e.g., 3 minutes after an occurrence of an event). A Real-time Alerts modifier may be characterized by attributes such as Audio alerts, or phone vibrations. In some examples, a class of modifiers can be defined, for example, Temporal Alerts, which can include different modifiers such as audio alerts. These modifiers can have attributes such as sound patter, volume, duration, and the like. A Rewards modifier may be characterized by attributes including money, gift cards, gas, electronics, and the like. A user can earn points, opportunities for chances to win prizes, and the like for demonstrating safe driving.

Modifier(s) 404 may also include modifiers related to Social Media and Competition. Social Media related modifiers, each characterized by different attribute(s) such as Posts to social media sites, other public sites, or the like, and Pledges for Social modifier, and Comparisons, such as a leaderboard, for Compete modifier. The comparisons may be made by demographic characteristics, geographic characteristics, team-based, friendship group base, or the like. In some examples, a “post” may be placed by a driver or group(s) of drivers (e.g., cohorts) to a social media page, and a “pledge” may include a promise by the driver or group(s) of drivers to a third party (e.g., friend or family) to perform an act (e.g., obey speed limits) or refrain from performing an act (e.g., not taking or placing a call) during driving.

Although exemplary behavior modifiers are illustrated in FIG. 4A, these examples are not intended to be exhaustive and other behavior modifiers are included within the scope of the present disclosure. Thus, the examples depicted are merely exemplary. In some examples, a set of modifiers is provided that can be modified, added to the set (e.g., a treatment), removed from the set, have attributes changed, supplemented, or the like as appropriate to the particular application. They can then be applied to different groups of people, that is, cohorts, which are themselves characterized by attributes. As discussed above, a cohort can be a collection of drivers to which treatments can be applied. Attributes for creating cohorts can include any one or combination of (as also shown in the figures):
Random collection and assignment of drivers
Weighted Distribution of drivers across groupings
Demographic
Geographic

Behavioral, which can include grouping by particular behaviors, that may be observed during an iterative approach. For example, a group may be defined to include those drivers who responded to a previous treatment or modifier.

Test Group—includes an ongoing group of users that new treatments can be applied against.

As an example, a company having a first cohort could utilize a first set of modifiers and another company having a second cohort could utilized a second set of modifiers that differed from the first set, either at the modifier level, at the attribute level, or both. For instance, certain of the modifiers (e.g., highly ranked modifiers) might prove to be not as effective as other modifiers and can drop down in a ranked list of modifiers, eventually being removed from the set. On the other hand, new modifiers/attributes can be introduced and their effectiveness measured, which can result in these new modifiers/attributes being made available more widely, moving up in a ranked list, or the like. Companies can be provided with a base set of modifiers or with an expanded set, for example, an expanded set that is available for a premium. As different companies apply different modifiers to different cohorts, performance of the various modifiers can be observed relative to other modifiers, enabling the most effective modifiers to be utilized more widely. The modification of the modifiers/attributes can be performed by the entity providing the modifiers, by companies accessing the provided modifiers, or both. Many other such variations, modifications, and alternatives may be used without departing from the spirit or scope of the present disclosure.

Modifiers, treatments, and the results of applying the modifiers to one or more drivers or cohorts may be stored in a Behavior Analytics Database. In some examples, the results can be pooled and/or crowdsourced across multiple domains (e.g., companies, individual drivers, cohorts, etc.). The database may provide a central location data is collected and used to identify, measure, and store the effectiveness of all modifiers and treatments.

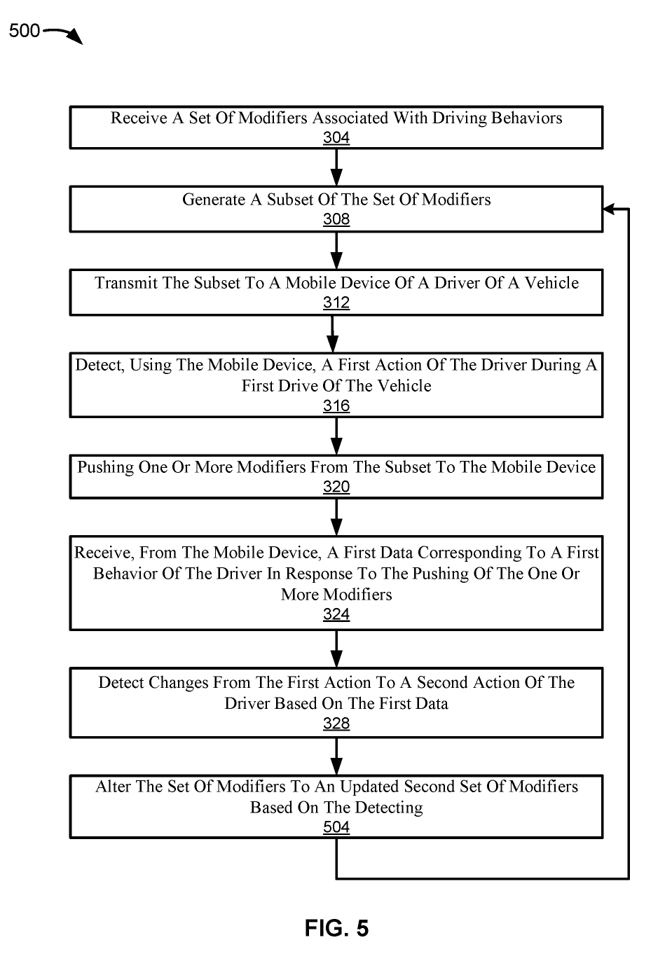

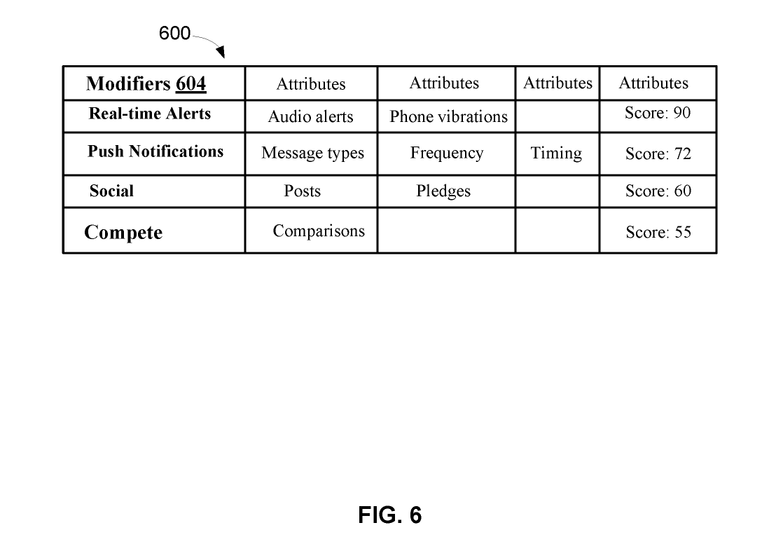

FIG. 5 is a simplified flowchart illustrating another method of updating behavior modifiers according to an embodiment of the present invention. Following blocks 304 through 328, as described above in conjunction with FIG. 3, in block 504, the set 400 of the modifiers 404 may be altered to an updated set 600 of modifiers 604 in a manner similar to that described above in conjunction with FIGS. 4A-4B. FIG. 6 is an exemplary chart illustrating an updated set of behavior modifiers according to an embodiment of the present invention. From the updated set 600 other subset(s) of modifier(s) can then be formed and provided to mobile device(s) 104 of driver(s) in the manner described above.

The modifier(s) provided to driver(s) may include compound modifiers having two or more modifiers, such as phone vibration followed by push notification after the drive, and provided on a periodic basis, such as daily, for a trip, after every fifth trip, as a summary of the driver performance, and/or the like.

In some instances, different modifier sets may be generated and assigned to different drivers, or group of drivers (e.g., cohorts) and used to measure the performance of each driver or cohorts, relative to the other drivers or cohorts. In some examples, a Compete modifier (as shown in FIG. 4A) includes a Comparisons attribute which may include leaderboards, or competition around leaderboards, such as performance by which driver (or a group of drivers) is demonstrating an increased level of improvement. In this way, one or more modifier(s) can be targeted at a particular group of drivers, including a control group (no modifiers at all), thus enabling the directing of different type of modifiers or compound modifiers to a specific group/cohort of users. Each cohort can then receive a different type of modifiers than others.

In some instances, based on the measured effectiveness (e.g., positive/negative change in behavior and/or risk relative to baseline) of modifier(s), a ranked listing of top performing modifier(s) can be aggregated based on the collective effectiveness determined across some or all drivers involved, so to identify the most effective modifier(s) for changing behavior of a driver, or a group of drivers. The changed behavior may then be quantified (e.g., monetarily), so that a group of drivers who were given an initial base-line risk could then be reduced to a lower base-line (reduced risk) in aggregate, and then a monetary value (e.g., dollar figure) can be assigned to indicate relative savings (less losses) to the driver(s) in the group.

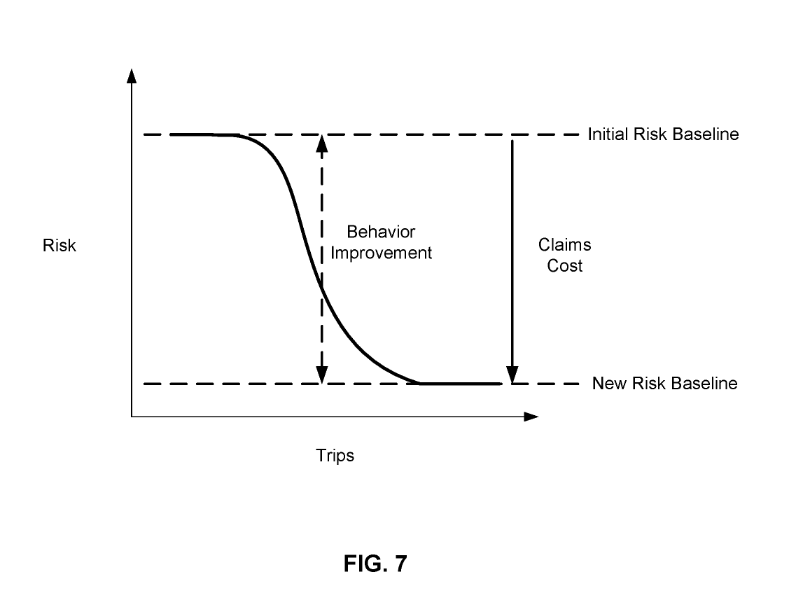

FIG. 7 is a simplified plot illustrating reduction in risk as a function of trips according to an embodiment of the present invention. In some instances, the present disclosure enables an initial risk baseline to be determined and as driver behavior improves in response to the use, updating, and selection of effective behavior modifiers, the new baseline risk decreases as a function of time. As a result, claims cost will decrease for an insurer as risk decreases.

The plot illustrated in FIG. 7 can be associated with one driver or a set/cohort of drivers. In some instances, different plots can be generated for individual drivers. In addition to graphical display, other techniques can be used to compare performance across a cohort as multiple performers are compared against each other. Filtering based on context (e.g., geography, season, weather conditions, or the like) can be utilized. Quantification of the value of the behavior change can be performed, e.g., a group of drivers that were given an initial base-line risk could then be reduced to a lower base-line (i.e., reduced risk) in the aggregate, and then a monetary amount can be assigned to indicate the relative savings resulting from a reduction in losses for the driver(s).

Additionally, the present disclosure describes methods and systems that incorporate and update treatments in user groups or cohorts.

In some examples, a system provides drivers with treatments using an ongoing process in which new treatments are being introduced, for example, frequently, and older treatments, which may have been identified as low performing treatments, are being removed. A treatment may be modified, created, or removed and pushed out to all drivers of a cohort or to a company (e.g., an insurer). The company could learn about new treatments in the form of a bulletin (e.g., delivered text messaging, email, etc.), which would describe the treatment purpose and expected behavior. It may also include a user interface display the performance in terms of “views” (i.e., how many drivers has the treatment been applied against) as well as an aggregate overall rating of its effectiveness, along with other supporting attributes as appropriate to the particular application. The company may review treatments, select treatments to apply the treatment to a cohort selected by the company, or a subset of the selected cohort, and/or the like.

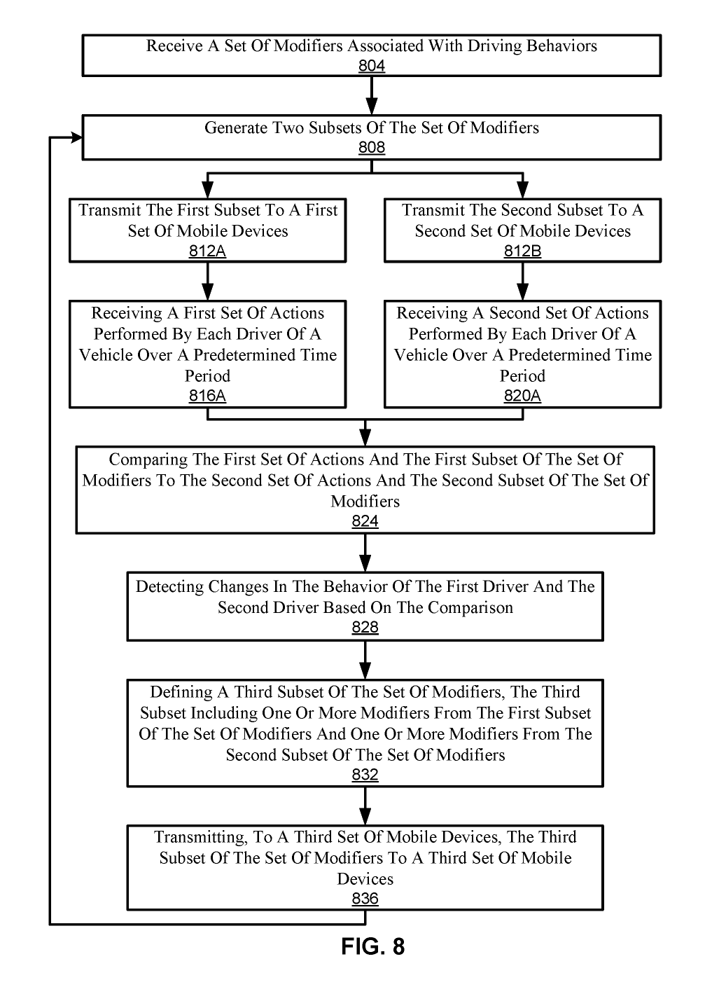

FIG. 8 depicts a simplified flowchart illustrating another method of aggregating results of behavior modifiers across multiple cohorts according to an embodiment of the present invention. The process begins at block 804 in which a set of modifiers associated with driving behaviors is received. The set of modifiers may be received from persistent memory (e.g., local memory), a database (e.g., locally or remotely maintained), from user input, and/or the like. The set of modifiers may include modifiers defined by one or more drivers, companies (e.g., insurers or employers of drivers), and/or the like. The set of modifiers may include new modifiers or previously defined and evaluated modifiers.

At block 808 two subsets of the set of modifiers can be generated. For example, a first user associated with a first company may define one or more first subsets of the set of modifiers for cohorts selected by the first user and/or first company. A second user associated with a second company may define one or more second subsets of the set of modifiers for cohorts selected by the second user and/or second company. In some examples, only a portion of the set of modifiers may be available for the first user and/or first company to select to include in the first subset of the set of modifiers. Likewise, the second user and/or second company may be limited to a different (but potentially overlapping) portion of the set of modifiers from the first user and/or first company. In other words, the one or more first subsets includes different combinations of modifiers from the one or more second subsets.

Cohorts may be defined based on one or more characteristics of a driver. For example, a cohort may be defined such only drivers that have one or more characteristics in common are included. In some examples, if there are more than a threshold amount of drivers having the corresponding characteristics, drivers may be selected (e.g., random sampling, by a user, etc.) until the cohort includes the threshold amount of drivers. The remaining drivers sharing the characteristics may be placed in a separate cohort or not placed in any cohort. For example, a first cohort may be selected to include drivers with a permanent address within a predetermined geographical area (e.g., the city of Boston, particular neighborhood, area code, zip code, etc.). Any characteristic of a driver such as, and by example only, age, sex, level of education, profession, type of vehicle, yearly salary, weight, health, driving history, legal history, race, sexual orientation, whether the driver rents or owns their home, combinations thereof, and/or the like may be used to define a cohort.

The modifiers selected by the first user and/or the second user may be based on one or more characteristics of the corresponding selected cohort including, but not limited to, any characteristic (e.g., as described above) used to define the cohort or any characteristic of a driver within the cohort.

In some examples, the first subset and the second subset may be distributed to mobile devices associated with a first cohort and a second cohort selected by a same user and/or company to enable the user/company to identify effective modifiers for a given driver characteristic. The first and second cohort may be analyzed to determine how different modifiers may contribute to reducing driving risk based on particular characteristics of a driver. For example, the first cohort may include drivers in an urban setting and the second cohort may include drivers from a rural setting. The evaluation of the modifiers pushed to each cohort may identify a modifier effective to rural drivers, but not city drivers or vice versa enabling the first user to define an effective subset of modifiers for a particular cohort. A new cohort may be defined to test the evaluation.

At block 812A and 812B, the first subsets of modifiers are transmitted to mobile devices associated with drivers selected to by the first user and/or first company (e.g., 812A) and the second subsets of modifiers are transmitted to mobile devices associated with drivers selected to by the second user and/or second company (e.g., 812B). Each company may select one or more cohorts (e.g., each including one or more drivers) to receive a treatment (e.g., a subset of the set of modifiers available to that company). Since each company has a separate set of drivers configured to receive modifiers, drivers associated with the first company may receive different modifiers from drivers associated with the second company. The modifiers may include one or more instructions executable by a mobile device associated with a driver (e.g., push notifications, SMS messages, emails, updating a driver profile, emitting a vibration and/or audible sound, and/or the like). Upon detecting triggering condition (e.g., a driving action such as an unsafe operation of a vehicle, distracted driving, etc.), the one or more instructions may be executed by a processor of the mobile device to trigger a communication (e.g., Push Notification, etc.). The modifiers may be executed upon detecting the condition, before a trip, or after a trip. Blocks 812A and 812B may be performed in series, or in parallel (as depicted), or at any time.

At block 816A and 816B, a first set of actions performed by drivers associated with the first user and/or first company may be received (e.g., 816A) and a second set of actions performed by drivers associated with the second user and/or second company may be received (e.g., 816B). Actions may include driving behavior associated with the driver that may be positive (e.g., driving within the speed limit, not following too close to another driver etc.) or negative (e.g., speeding, sudden braking, swerving, texting, making phone calls, interacting with the mobile device, etc.) that occurred over a predetermined monitoring period (e.g., 50 days, etc.). The set of actions may include ancillary data associated with each detected action including, but not limited to, environmental conditions, whether, GPS, time of occurrence, and/or the like. Blocks 816A and 816B may be performed in series, or in parallel (as depicted), or at any time.

At block 824, the first set of actions and the first subsets of modifiers may be compared to the second set of actions and the second subsets of modifiers. For example, a user interface may display the results of each driver over the predetermined monitoring period and the results of each group (e.g., the drivers associated with both companies). The results may indicate which modifiers and/or combinations of modifiers were more effective in reducing particular types of actions of drivers. In some examples, the first set of actions may be analyzed as actions occurring over the predetermined monitoring period to identify how the behavior of the driver changes over time. For example, a speeding action may be detected in a set of actions of a driver more frequently in the initial monitoring period and less frequency in the end of the monitoring period indicating that a modifier successfully reduced the driver's habit of speeding. In other examples, the set of actions may be compared to a baseline (e.g., a set of actions detected without the application of modifiers). For example, a set of actions may be detected during previous predetermined monitoring period without modifiers. That set of actions may be compared to the set of actions in which modifiers were used to shape the behavior of the driver to evaluate an effectiveness of the modifiers.

At the first set of actions and the first subsets of modifiers may be compared to the second set of actions and the second subsets of modifiers in order to determine, both the effectiveness of the individual modifiers and the effectiveness of the combination of modifiers included in each respective subset. The comparison may enable an indication that the first subset of modifiers was more effective than the second subset of modifiers. In some examples, a subsequent analysis on the individual cohorts may identify whether the cause of the difference in effectiveness was due to differences in the characteristics of each respective cohort or the modifiers of each corresponding subset.

At block 828, a change in behavior may be detected in the drivers associated with the first set of mobile device and driver associated with the second set of mobile device. For example, a reduction in distracted driving may be detected in the first set of drivers as a result of a Real-time Alert modifier. A reduction in an action type may be detected in the second set of drivers as well that may be the same action type or a different action type (e.g., based on the second set of drivers being exposed to different modifiers). The change in behaviors may cause each of the modifications in the first subset of modifiers and each of the modifications in the second subset of modifiers to have their respective scores updated. In some examples, each subset of modifiers may include an overall score based on the effectiveness of each modifier in the subset. The change in behavior may also cause the overall score of each corresponding modifier to be updated.

At block 832, a third subset of modifiers may be defined based on the changes behavior detected at block 828. The third subset of modifiers may include one or more modifiers from the first subset of modifiers, one or more modifiers from the second subset of modifiers, and/or one or more new modifiers. For example, the third subset of modifiers may include a collection of modifiers unavailable to either of the first company or the second company and include those modifiers that have a tested effectiveness resulting from the application of the modifiers by the first company or the second company. In other examples, the third subset may be include modifiers from the first subset and the second subset with the highest effectiveness score (e.g., those above a threshold score). The third subset may be provided to the first company or the second company at a revised rate (e.g., based on the revised individual effectiveness score), to the same mobile devices (e.g., cohort) as the first subset and/or second subset or a different (but potentially overlapping) cohort selected by the first company and/or second company, and/or to a third company.

At block 836, the third subset of modifiers may be provided to one or more mobile devices. The one or more mobile devices may be associated and selected by a third company (e.g., an insurer, ridesharing company, employer, etc.) or may be drivers selected by the first company or the second company. For example, the blocks 804-828 may be used to aggregate data on the effectiveness of modifiers are different cohorts and across cohort to determine the effectiveness of different modifiers. The modifiers shown to be most effective may then be selected for use by a third company on an new set of drivers.

Specific details are given in the above description to provide a thorough understanding of the embodiments and examples. However, it is understood that the embodiments and/or examples described above may be practiced without these specific details. For example, well-known circuits, processes, algorithms, structures, and techniques may be shown without unnecessary detail in order to avoid obscuring the embodiments and/or examples.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), mask programmable gate array (MPGA), processors, controllers, micro-controllers, microprocessors, other electronic units designed to perform the functions described above, and/or combinations thereof.

Also, it is noted that the embodiments and/or examples may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, one or more of the operations may be performed out-of-order from the order depicted. A process may terminate when its operations are completed or return to a previous step or block. A process could have additional steps or blocks not included in the figure. A process may correspond to a method, a function, a procedure, a subroutine, a subprogram, etc. When a process corresponds to a function, its termination corresponds to a return of the function to a calling function or a main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a non-transitory computer-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any non-transitory computer-readable medium tangibly embodying instructions may be used in implementing the methodologies described herein. For example, software codes may be stored in a memory. Memory may be implemented within the processor or external to the processor. As used herein the term “memory” refers to any type of volatile, non-volatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, cache memory, magnetic disk storage mediums, optical storage mediums, flash memory devices and/or other machine readable mediums for storing information. The term “computer-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method comprising:
receiving a set of modifiers associated with driving behaviors;
generating a subset of the set of modifiers;
transmitting the subset of the set of modifiers to a mobile device associated with a driver of a vehicle;
detecting, using the mobile device, a first action performed by the driver during a first operation of the vehicle;
pushing one or more modifiers from the subset to the mobile device;
receiving, from the mobile device, a first dataset corresponding to a first behavior of the driver in response to transmitting the one or more modifiers;
detecting changes from the first action to a second action of the driver based on the first dataset;
altering the subset of the set of modifiers to an updated subset of the set of modifiers based on detecting changes from the first action to a second action of the driver; and
transmitting the updated subset of the set of modifiers to the mobile device of the driver.

2. The method of claim 1 wherein detecting changes comprises:
receiving, from the mobile device, a second dataset corresponding to the second action during a subsequent use of the vehicle by the driver; and
comparing the first dataset with the second dataset.

3. The method of claim 1 wherein altering the subset of the set of modifiers comprises adding modifiers to the set of modifiers.

4. The method of claim 1 wherein altering the subset of the set of modifiers comprises removing at least one modifier from the set of modifiers.

5. The method of claim 1 further comprising generating the subset of the set of modifiers prior to receiving the first dataset.

6. The method of claim 1 wherein detecting changes from the first action to the second action occurs over a predetermined time period.

7. The method of claim 1 wherein altering the subset of the set of modifiers is based on comparing the changes to a predetermined effectiveness threshold for the one or more modifiers.

8. The method of claim 1 wherein transmitting the subset to a mobile device associated with a driver of a vehicle further comprising assigning the subset of the set of modifiers to a profile associated with the driver of the vehicle.

9. The method of claim 1 further comprising:
comparing the second action to a predetermined behavior; and
determining, over a predetermined time period, a deviation of the second action from the predetermined behavior in response to transmitting the updated subset of the set of modifiers to the mobile device of the driver.

10. A method comprising:
receiving a set of modifiers associated with driving behaviors;
generating a first subset of the set of modifiers;
transmitting the first subset to a mobile device of a driver of a vehicle;
detecting, using the mobile device, a first action of the driver during a first drive of the vehicle;
pushing one or more modifiers from the first subset of the set of modifiers to the mobile device;
receiving, from the mobile device, a first data corresponding to a first behavior of the driver in response to transmitting the one or more modifiers;
detecting changes from the first action to a second action of the driver based on the first data; and
altering the set of modifiers to an updated second set of modifiers based on the detecting.

11. The method of claim 10 further comprising:
generating a second subset of the set of modifiers; and
transmitting the second subset of the set of modifiers to the mobile device of the driver.

12. The method of claim 10 further comprising:
transmitting the first subset of the set of modifiers to a plurality of mobile devices wherein at least two mobile devices in the plurality of mobile devices correspond to different drivers of different vehicles;
detecting, using the plurality of mobile devices, second actions corresponding to the different drivers during a second operation of each corresponding vehicle;
pushing one or more modifiers from the first subset to the plurality of mobile devices;
receiving, from the plurality of mobile devices, a second dataset corresponding to a second behavior of the different drivers in response to pushing the one or more modifiers;
detecting a change from the second actions to third actions in the different drivers based on the second dataset; and
altering the first subset of the set of modifiers to an new subset of the set of modifiers based on detecting a change from the second actions to third actions.

13. A method comprising:
receiving a set of modifiers associated with driving behaviors;
generating a first subset of the set of modifiers and a second subset of the set of modifiers, wherein the first subset of the set of modifiers and the second subset of the set of modifiers include a different collection of modifiers;
transmitting the first subset of the set of modifiers to a first set of mobile devices, each mobile device of the first set of mobile devices being associated with a driver of a vehicle, wherein each mobile device of the first set of mobile devices is configured to detect an action associated with a first modifier of the first subset of the set of modifiers and execute instructions to perform the first modifier;
transmitting the second subset of the set of modifiers to a second set of mobile devices, each mobile device of the second set of mobile devices being associated with a driver of a vehicle, wherein each mobile device of the second set of mobile devices is configured to detect an action associated with a second modifier of the second subset of the set of modifiers and execute instructions to perform the second modifier;
receiving, from each mobile device of the first set of mobile devices, a first set of actions performed over a predetermined time period by a driver of the vehicle that is associated with the mobile device;
receiving, from each mobile device of the second set of mobile devices, a second set of actions performed over a predetermined time period by a driver of the vehicle that is associated with the mobile device;
comparing the first set of actions and the first subset of the set of modifiers to the second set of actions and the second subset of the set of modifiers;
defining, based on comparing the first set of actions and the first subset of the set of modifiers to the second set of actions and the second subset of the set of modifiers, a third subset of the set of modifiers, the third subset including one or more modifiers from the first subset of the set of modifiers and one or more modifiers from the second subset of the set of modifiers; and
transmitting the third subset of the set of modifiers to a third set of mobile devices, each mobile device of the third set of mobile devices being associated with a driver of a vehicle.

14. The method of claim 13, wherein comparing the first set of actions and the first subset of the set of modifiers to the second set of actions and the second subset of the set of modifiers comprises:
generating a score associated with each modifier of the first subset of the set of modifiers and the second subset of the set of modifiers based on an effectiveness of the modifier in reducing a frequency in which an action type is performed by a driver.

15. The method of claim 13, wherein the third subset of the set of modifiers includes modifiers that have reduced an occurrence of an action type performed by a driver based on the first set of actions and the second set of actions.

16. The method of claim 13, wherein the third subset of the set of modifiers includes a new modifier that was not included in the first subset of the set of modifiers or the second subset of the set of modifiers.

17. The method of claim 13, wherein the third subset of the set of modifiers includes a modifier that was included in both the first subset of the set of modifiers and the second subset of the set of modifiers.

18. The method of claim 13, further comprising:
receiving, from each mobile device of the third set of mobile devices, a third set of actions performed by the driver of the vehicle over a predetermined time period;
comparing the third set of actions and the third subset of the set of modifiers to the first set of actions, the first subset of the set of modifiers, the second set of actions, and the second subset of the set of modifiers; and
identifying a change in a behavior of one or more drivers having mobile devices included in the third set of mobile devices in response to comparing the third set of actions and the third subset of the set of modifiers to the first set of actions, the first subset of the set of modifiers, the second set of actions, and the second subset of the set of modifiers.

19. The method of claim 18, further comprising:
altering the third subset of the set of modifiers to an updated third subset of the set of modifiers based on identifying the change in the behavior of one or more drivers; and
transmitting the updated third subset of the set of modifiers to the third set of mobile devices.

20. The method of claim 13, further comprising:
receiving a selection of the first set of mobile devices from a larger set of mobile devices, wherein each mobile devise of the first set of mobile devices having been selected based one or more common characteristics of a driver associated with the mobile device.
